(19) United States
(12) Patent Application Publication
(10) Pub. No.: US 2003/0137070 A1
(43) Pub. Date: Jul. 24, 2003

(54) Apparatus for producing foam moldings

(76) Inventors: Joachim Hund, St Martin (DE); Peter Dillmann, Insheim (DE)

Correspondence Address: Herbert B. Keil, KEIL & WEINKAUF, 1350 Connecticut Ave., N.W., Washington, DC, 20036, US

(21) Appl. No.: 10/321,480

(22) Filed: Dec. 18, 2002

(30) Foreign Application Priority Data
Jan. 18, 2002 (DE) 10202042.6

(51) Int. Cl. B29C 44/02

(52) U.S. Cl. 264/41; 425/4 R; 425/817 R

(57) ABSTRACT

The invention relates to an apparatus and a process for producing foam moldings by sintering prefoamed polymer particles by means of superheated steam in a mold which has been arranged in a steam chamber into which the superheated steam is introduced and from there forces its way though nozzles into the mold. The inner walls of the steam chamber have been coated with a cured epoxy resin.

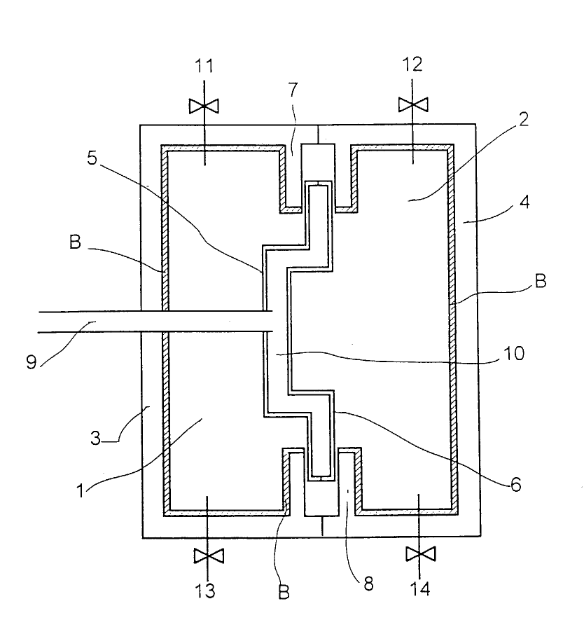

The invention relates to an apparatus and a process for producing foam moldings by sintering preformed polymer beads by means of superheated steam in a multipart mold which has been arranged in a steam chamber into which the superheated steam is introduced and from there its way through nozzles into the mold.

The process is used on an industrial scale for producing foam moldings, e.g. those based on polystyrene (EPS) or polypropylene (EPP). The process introduces steam, the temperature of which is 100° for EPS and about 150° for EPP, into the steam chamber, and from there the steam forces its way through narrow nozzles into sintering of the preformed beads previously charged at superatmospheric pressure. Once sintering has ended, the blowing pressure is dissipated and the outer walls of the mold are cooled by spraying with water, and the mold is opened and the finished molding is removed.

The walls of the steam chamber are generally composed of metal, which is a good conductor of heat. When steam is applied, these walls absorb a relatively large amount of heat, which they release into the coolant water during the cooling process. The result is high energy loss. Various measures have previously been adopted in order to reduce this loss. When moldings are produced from EPS, rubber mats can vulcanized onto the inner wall of the steam chamber. However, these are not sufficiently heat-resistant for EPP. It has also been proposed that sheets made from thermally insulating materials, e.g. from ceramics or from plastic, be applied to the steam chamber walls. However, this is difficult because the walls are uneven, and thermal bridging always arises. When the inner walls are coated with ceramics there is a risk that these flake off due to constant change in temperature.

It is an object of the present invention, therefore to eliminate these disadvantages.

We have found that this object is achieved if excellent thermal insulation is obtained by coating the inner walls of the steam chamber with a cured epoxy resin. Unlike other types of polymer coatings, epoxy resins are resistant to heat and hydrolysis and do not break or split even when subject to severe temperature variation. The epoxy resins have preferably been filled with inorganic fillers, e.g. silicates, oxides, or carbonates, and then have densities above 1.5 g/cm³, in particular from 2.0 to 3.0 g/cm³. The thickness of the coating is advantageously fro 200 to 2000 μm, preferably from 500 to 1200 μm. It is produced by applying, to the inner walls, a premix of an epoxy resin, e.g. based on bisphenols, novolaks, or diols, with a hardener, e.g. based on diamine. This may be achieved by doctoring, troweling, or simple brushing. The epoxy resin is allowed to cure after application ,and the curing can be accelerated by heating.

The figure shows a drawing of the apparatus of the invention. 1 and 2 indicate the two halves of the steam chamber, and 3 and 4 indicate its inner walls, namely the retainer plate 3 and the backing plate 4. 5 and 6 re the two halves of the mold, which is held by mold clamping plates 7 and 8. According to the invention, the inner walls of the steam chamber and the mold clamping plates have been coated with the cured epoxy resin B. The inlet injector 9 charges the prefoamed polymer beads into the interior 10 of the mold, preferably at superatmospheric pressure. Then first the steam supply valve 11 and the condensate valve 14 are opened, so that steam flows into one of the halves 1 of the steam chamber and through the condensate valve 14. This procedure is repeated by opening the steam supply valve 12 and condensate-valve 13, whereupon the steam flow proceeds in the opposite direction through the mold. The effect of the superheated steam is that the prefoamed polymer beads first expand further and expel the air located in the interstices, and finally sinter to give the foam molding. The blowing pressure is then dissipated and cooling water is sprayed onto the mold through nozzles—not included in the drawing—thus permitting cooling and opening of the mold. Finally, the finished molding is removed.

The process of the invention may be used to produce foam moldings from thermoplastics, e.g. polyolefins or styrene polymers, and particularly advantageously propylene polymers, the prefoamed EPP beads preferably having a bulk density of from 10 to 200 g/l.

We claim:

1. An apparatus for producing foam moldings by sintering prefoamed polymer beads by means of superheated steam in a multipart mold which has been arranged in a steam chamber into which the superheated steam is introduced and from there forces its way through nozzles in the mold, wherein the inner walls of the steam chamber have been coated with a cured epoxy resin for thermal insulation.

2. An apparatus as claimed in claim 1, wherein the epoxy resin has been filled with in inorganic filler and has a density above 1.5 g/cm³.

3. An apparatus as claimed in claim1, wherein the epoxy resin coating has a thickness of from 200 to 2000 μm.

4. A process for producing foam moldings by sintering prefoamed polymer beads, which comprises carrying out the sintering in an apparatus as claimed in claim 1.

5. A process as claimed in claim 4, wherein prefoamed polypropylene beads with a bulk density of form 10 to 200 g/l are sintered.

6. A process as claimed in claim 4, wherein prefoamed polystyrene beads are sintered.

7. A process as claimed in claim 4, wherein prefoamed polyethylene beads are sintered.
